(19) United States
(12) Patent Application Publication
(10) Pub. No.: US 2025/0392829 A1
(43) Pub. Date: Dec. 25, 2025

(54) IMAGING APPARATUS

(71) Applicant: CANON KABUSHIKI KAISHA, Tokyo (JP)

(72) Inventor: SHOTA WADA, Kanagawa (JP)

(21) Appl. No.: 19/241,136

(22) Filed: Jun. 17, 2025

(30) Foreign Application Priority Data
Jun. 19, 2024 (JP) 2024-099180

(51) Int. Cl. H04N 23/81; G03B 17/14; H04N 23/52; H04N 23/55; H04N 23/58; H04N 23/667

(52) U.S. Cl. CPC H04N 23/811; G03B 17/14; H04N 23/52; H04N 23/55; H04N 23/58; H04N 23/667

(57) ABSTRACT

An imaging apparatus includes an imaging unit including an image pickup element, a rotary drive unit configured to rotate the imaging unit in a horizontal direction or a vertical direction, an image pickup element vibration unit configured to vibrate the image pickup element to remove a foreign substance adhering to an imaging plane of the image pickup element, and a control unit configured to control the image pickup element vibration unit to operate in a state where the imaging unit is rotated by the rotary drive unit so that the imaging plane of the image pickup element is at a predetermined angle with respect to a gravitational direction.

### BACKGROUND

### Field of the Disclosure

The present disclosure relates to an imaging apparatus.

### Description of the Related Art

In an imaging apparatus such as a digital camera, when a foreign substance such as dust adheres to an imaging plane of an image pickup element, there is a case where a shadow of the foreign substance or the like is reflected on a captured image. As discussed in Japanese Patent Application Laid-Open No. 2007-189401, there is a technique of vibrating an image pickup element to remove a foreign substance on the imaging plane of the image pickup element.

An imaging apparatus is known that includes a panning/tilting mechanism for automatically rotating an imaging unit in a panning/tilting direction, and that drives the panning/tilting mechanism through remote manipulation or the like to capture an image in a desired direction. It is desirable to remove a foreign substance adhering to an imaging plane of an image pickup element also in such an imaging apparatus including the panning/tilting mechanism.

However, in the imaging apparatus that drives the panning/tilting mechanism to capture an image through remote manipulation or the like, it is necessary to manipulate the imaging apparatus that is installed in a distant location from a position where a user performs the manipulation. Thus, there is an issue that the user has a difficulty to intuitively determine a direction of the imaging plane of the image pickup element and appropriately remove the foreign substance adhering to the image pickup element.

### SUMMARY

According to embodiments of the present disclosure, an imaging apparatus includes an imaging unit including an image pickup element, a rotary drive unit configured to rotate the imaging unit in a horizontal direction or a vertical direction, an image pickup element vibration unit configured to vibrate the image pickup element to remove a foreign substance adhering to an imaging plane of the image pickup element, and a control unit configured to control the image pickup element vibration unit to operate in a state where the imaging unit is rotated by the rotary drive unit so that the imaging plane of the image pickup element is at a predetermined angle with respect to a gravitational direction.

Further features of the present disclosure will become apparent from the following description of exemplary embodiments with reference to the attached drawings.

### BRIEF DESCRIPTION OF THE DRAWINGS

FIG. 1 is a configuration diagram of an imaging apparatus according to a first exemplary embodiment.

FIG. 2 is a block diagram of a control unit according to the first exemplary embodiment.

FIGS. 3A to 3C are diagrams for describing execution of a foreign substance removal operation according to the first exemplary embodiment.

FIG. 4 is a flowchart for implementing the first exemplary embodiment.

FIGS. 5A to 5C are diagrams for describing execution of a foreign substance removal operation according to a second exemplary embodiment.

FIG. 6 is a flowchart for implementing a third exemplary embodiment.

FIGS. 7A and 7B are diagrams for describing a display apparatus connected to the imaging apparatus according to a fourth exemplary embodiment.

FIG. 8 is a flowchart for implementing a fourth exemplary embodiment.

### DESCRIPTION OF THE EMBODIMENTS

Exemplary embodiments of the present disclosure will be described in detail with reference to the accompanying drawings. Configurations described in the following exemplary embodiments are merely examples, and the present disclosure is not necessarily limited to the configurations illustrated in the drawings.

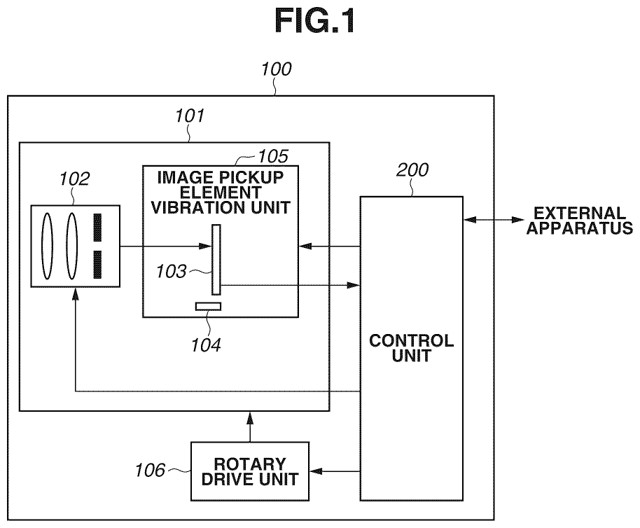

FIG. 1 is a configuration diagram of an imaging apparatus according to a first exemplary embodiment. As illustrated in FIG. 1, an imaging apparatus 100 includes an imaging unit 101, a rotary drive unit 106, and a control unit 200. The imaging unit 101 includes a lens unit 102, an image pickup element 103, an absorption member 104, and an image pickup element vibration unit 105.

The lens unit 102 includes a zoom lens, a focus lens, and a stop mechanism, and condenses light from a subject onto a light-receiving surface of the image pickup element 103. The zoom lens is capable of moving in an optical-axis direction and changing an imaging magnification. The focus lens is capable of moving in the optical-axis direction and adjusting a focus position. The stop mechanism is capable of adjusting a light amount of light that passes through an optical system. Each lens and the stop mechanism include corresponding drive units, which are controlled by the control unit 200.

The image pickup element 103 includes a semiconductor element such as a complementary metal-oxide semiconductor (CMOS) sensor or a charge-coupled device (CCD) sensor. The image pickup element 103 photoelectrically converts a subject image formed by the lens unit 102 to generate an analog signal.

The absorption member 104 is installed on a vertically lower side of the image pickup element 103. The absorption member 104 includes an adhesive layer, and is capable of absorbing a foreign substance that drops from the above.

A cover glass plate that protects an optical low-pass filter and the image pickup element 103 is disposed on a front surface of the image pickup element 103. The image pickup element vibration unit 105 includes a vibration mechanism that vibrates the optical low-pass filter and the cover glass plate or the image pickup element 103 itself. The image pickup element vibration unit 105 vibrates the optical low-pass filter and the cover glass plate or the image pickup element 103 itself, and thereby executes a foreign substance removal operation to remove a foreign substance on the imaging plane of the image pickup element 103.

The rotary drive unit 106 includes a drive mechanism composed of a motor and a reduction gear for rotating the imaging unit 101 in a panning direction (horizontal direction) and a tilting direction (vertical direction) based on a drive signal from the control unit 200.

The rotary drive unit 106 is equipped with a photo-interrupter serving as a rotation position detection unit, and the photo-interrupter is capable of detecting a rotation position of the imaging unit 101 rotated by the rotary drive unit 106. The rotation position detection unit that detects the rotation position of the imaging unit 101 is not limited to the photo-interrupter. For example, the rotation position of the imaging unit 101 may be detected by another means such as a magnetic encoder or an optical encoder.

The control unit 200 is a system control unit that performs integrated control of each constituent element of the imaging apparatus 100 and performs data transmission/reception or the like.

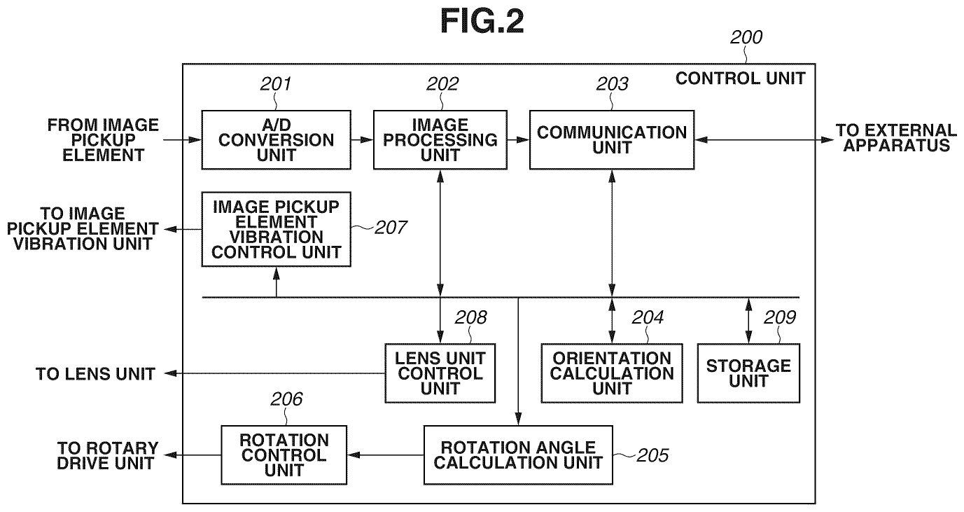

FIG. 2 is a block diagram of the control unit 200. As illustrated in FIG. 2, the control unit 200 includes an analog/digital (A/D) conversion unit 201, an image processing unit 202, a communication unit 203, an orientation calculation unit 204, a rotation angle calculation unit 205, a rotation control unit 206, an image pickup element vibration control unit 207, a lens unit control unit 208, and a storage unit 209.

The A/D conversion unit 201 converts an analog signal output from the image pickup element 103 into a digital signal, and outputs the digital signal to the image processing unit 202. The A/D conversion unit 201 may be built into the image pickup element 103.

The image processing unit 202 performs signal processing including exposure adjustment on the digital signal converted by the A/D conversion unit 201 using a digital gain, demosaicing processing, white balance processing, and gamma processing, and the like, to generate image data.

The communication unit 203 transfers the image data generated by the image processing unit 202 to an external apparatus such as a personal computer (PC), a display apparatus, or another medium (for example, a hard disk, a memory card, a Secure Digital (SD) Card, or a universal serial bus (USB)). The communication unit 203 accepts an instruction from an external apparatus such as a controller. The imaging apparatus 100 operates based on the instruction that has been transmitted from the external apparatus and that has been received by the communication unit 203.

The orientation calculation unit 204 calculates an inclination of the imaging plane of the image pickup element 103, which is an angle of the imaging plane with respect to a gravitational direction, based on a driving angle of the motor and a configuration of the reduction gear, using the rotation position detected by the photo-interrupter provided in the rotary drive unit 106 as a reference. The rotation angle calculation unit 205 calculates a driving amount of the imaging unit 101 to be driven by the rotary drive unit 106 to make the imaging plane of the image pickup element 103 parallel to the gravitational direction, from angle information regarding the angle of the image pickup element 103, which has been calculated by the orientation calculation unit 204. The rotation control unit 206 controls the rotary drive unit 106 based on the driving amount calculated by the rotation angle calculation unit 205.

The lens unit control unit 208 controls various kinds of driving of the lens unit 102 such as positional adjustment of the zoom lens and the focus lens or stop control in accordance with subject luminance. The storage unit 209 includes a volatile memory such as a static random access memory (SRAM) or a dynamic random access memory (DRAM) and a non-volatile memory such as an electrically erasable programmable read-only memory (EEPROM) or a flash memory. Results of calculation by the orientation calculation unit 204 and the rotation angle calculation unit 205 and the like are stored in the volatile memory, and various kinds of operation programs in the control unit 200 and the like are stored in the non-volatile memory.

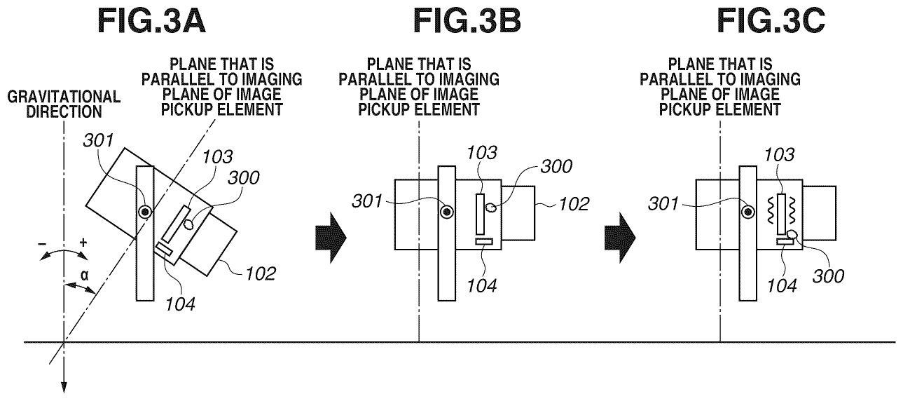

A foreign substance removal operation in the imaging apparatus 100 including a rotary drive mechanism will be described with reference to FIGS. 3A to 3C. FIGS. 3A to 3C are diagrams for describing execution of the foreign substance removal operation in the imaging apparatus 100.

FIGS. 3A to 3C each illustrate the lens unit 102, the image pickup element 103, and the absorption member 104 in the imaging unit 101 of the imaging apparatus 100, and a foreign substance 300 adheres to the imaging plane of the image pickup element 103. The imaging unit 101 rotates about a rotary shaft 301 in the tilting direction.

As illustrated in FIG. 3A, assume that an angle between the imaging plane of the image pickup element 103 and the gravitational direction is an angle a. FIG. 3A illustrates a case where the angle a is, out of a plus direction and a minus direction indicated in FIG. 3A, in the plus direction in which the imaging direction of the imaging unit 101 faces downward.

The orientation calculation unit 204 calculates the angle a based on the driving angle of the motor and the configuration of the reduction gear, using the rotation position of the imaging unit 101, which has been detected by the photo-interrupter, as a reference.

The rotation angle calculation unit 205 calculates the driving amount for rotating the imaging unit 101 in the tilting direction by the rotary drive unit 106 by the angle a in the minus direction indicated in FIG. 3A. The imaging apparatus 100 may be equipped with an orientation detection unit such as a gyro sensor and the rotation angle calculation unit 205 may calculate the angle a of the imaging plane of the image pickup element 103 with respect to the gravitational direction based on a detection result from the orientation detection unit.

The rotary drive unit 106 rotates the imaging unit 101 based on a calculation result from the rotation angle calculation unit 205 so that the imaging plane of the image pickup element 103 is parallel to the gravitational direction as illustrated in FIG. 3B. Thereafter, as illustrated in FIG. 3C, the image pickup element vibration unit 105 is driven to vibrate the image pickup element 103 and remove the foreign substance 300 on the imaging plane of the image pickup element 103.

At this time, the foreign substance 300 removed from the imaging plane of the image pickup element 103 drops to the absorption member 104 installed on the vertically lower side of the image pickup element 103, and is absorbed onto the surface of the absorption member 104. In this way, the foreign substance 300 removed from the image pickup element 103 is prevented from being absorbed onto another part in the imaging unit 101.

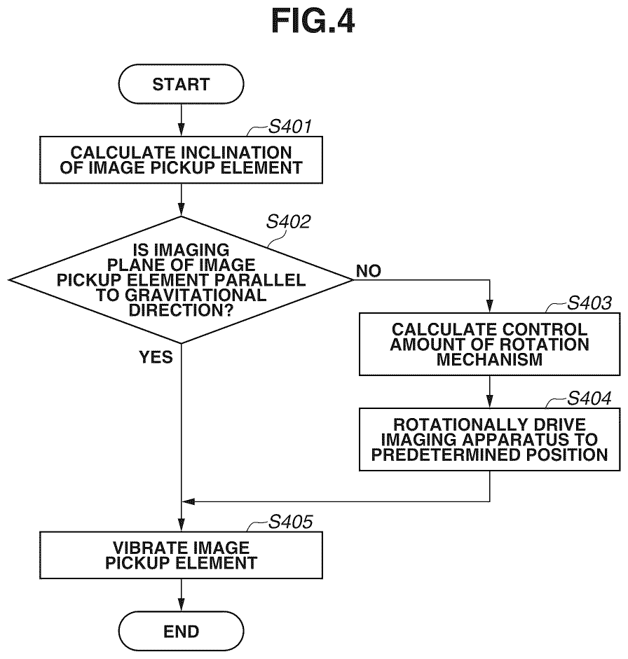

FIG. 4 is a flowchart regarding the foreign substance removal operation according to the present exemplary embodiment. The foreign substance removal operation according to the present exemplary embodiment is now described with reference to FIG. 4.

In step S401, the orientation calculation unit 204 calculates the inclination of the imaging plane of the image pickup element 103 as the angle of the imaging plane with respect to the gravitational direction, based on the driving angle of the motor and the configuration of the reduction gear, using the rotation position of the imaging unit 101, which has been detected by the photo-interrupter, as a reference. Then, the processing proceeds to step S402.

In step S402, the control unit 200 determines whether the imaging plane of the image pickup element 103 is parallel to the gravitational direction, based on the angle of the imaging plane of the image pickup element 103 with respect to the gravitational direction, which has been calculated in step S401. In a case where the control unit 200 determines that the imaging plane of the image pickup element 103 is parallel to the gravitational direction (YES in step S402), the processing proceeds to step S405. In a case where the control unit 200 determines that the imaging plane of the image pickup element 103 is not parallel to the gravitational direction (NO in step S402), the processing proceeds to step S403.

In step S403, the rotation angle calculation unit 205 calculates, based on the angle information regarding the angle (inclination) calculated in step S401, a rotational driving amount of the imaging unit 101 to be driven by the rotary drive unit 106 so that the imaging plane of the image pickup element 103 is parallel to the gravitational direction, and the processing proceeds to step S404.

In step S404, the rotary drive unit 106 rotates the imaging unit 101 based on the rotational driving amount calculated by the rotation angle calculation unit 205, and the processing proceeds to step S405.

In step S405, the image pickup element vibration unit 105 is driven to vibrate the image pickup element 103 and remove the foreign substance adhering to the imaging plane of the image pickup element 103, and the present flow ends.

According to the present exemplary embodiment, in the imaging apparatus 100 including the tilting mechanism, it is possible to automatically adjust the direction of the imaging plane of the image pickup element 103 without the need for the user to manually operating the tilting mechanism and easily execute the foreign substance removal operation.

While the description has been given of the example of executing the foreign substance removal operation in the case where the imaging plane of the image pickup element 103 is parallel to the gravitational direction in the present exemplary embodiment, the imaging plane may not be necessarily parallel to the gravitational direction. For example, the control unit 200 may perform control to drive the image pickup element vibration unit 105 and remove the foreign substance on the imaging plane of the image pickup element 103 in a case where the angle a illustrated in FIG. 3A is in a range approximately from a plus 30 degrees to a minus 30 degrees.

Since the foreign substance removed from the imaging plane drops downward in the gravitational direction, most of the foreign substance is absorbed onto the absorption member 104 installed in the vertically lower side of the image pickup element 103 if the angle a is in the range approximately from the plus 30 degrees to the minus 30 degrees. However, as the angle a becomes closer to 0, there is a higher possibility that the foreign substance removed from the imaging plane of the image pickup element 103 is absorbed onto the absorption member 104.

The rotary drive unit 106 may include, in addition to the rotary drive mechanisms in the panning direction and the tilting direction, a rotary drive mechanism in a different rotation direction such as a yawing direction. Furthermore, the rotation direction of the imaging unit 101 to be rotated by the rotary drive unit 106 at the time of execution of the foreign substance removal operation may be a rotation direction that is different from the panning direction and the tilting direction. For example, in a case where the imaging apparatus 100 is installed in a location not parallel to the ground surface, such as a wall surface, the direction of the imaging plane of the image pickup element 103 may be adjusted by rotationally driving the imaging unit 101 in a direction other than the panning direction and the tilting direction.

In this case, the imaging apparatus 100 is equipped with the orientation detection unit such as the gyro sensor, and determines the direction of an installation surface of the imaging apparatus 100 based on the detection result from the orientation detection unit and a driving amount of a panning or tilting mechanism. The imaging unit 101 is rotationally driven also in the rotation direction other than the tilting direction, whereby it becomes possible to set the imaging plane of the image pickup element 103 in a predetermined direction even in a case were the installation location of the imaging apparatus 100 is not parallel to the ground surface.

During execution of the foreign substance removal operation, the imaging apparatus 100 may not accept an instruction for rotationally driving the imaging unit 101 except an instruction regarding the foreign substance removal operation. The rotary drive unit 106 rotationally drives the imaging unit 101 by a driving amount based on a calculation result, and can thereby set the imaging plane of the image pickup element 103 in a desired direction.

A video that has been captured during the foreign substance removal operation may not be streamed. Not streaming the video during the foreign substance removal operation makes it possible to prevent streaming video that is disturbed by rotational driving of the rotary drive unit 106 or vibrating driving of the image pickup element 103 during the foreign substance removal operation.

In a second exemplary embodiment, a description will be given of a case where the imaging apparatus 100 is a lens-interchangeable imaging apparatus to which the lens unit 102 is detachably mounted. The lens unit 102 includes a memory that stores identification data indicating a type of the lens unit 102 or the like. The lens unit 102 includes an electric contact to communicate with the imaging apparatus 100.

When the lens unit 102 is mounted on a lens mount unit in the imaging unit 101, the lens unit 102 and the imaging apparatus 100 communicate with each other, and identify the type of the lens unit 102 or the like based on the identification data transmitted from the lens unit 102. The imaging apparatus 100 is capable of determining whether the lens unit 102 is mounted on the imaging apparatus 100 based on a state of communication with the lens unit 102.

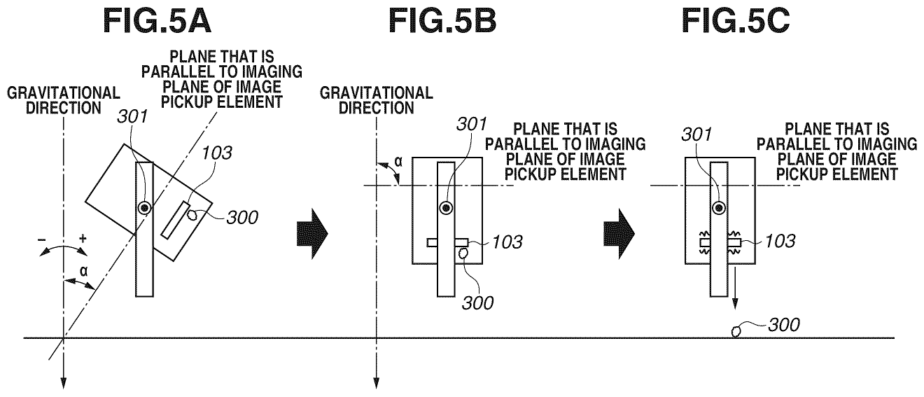

FIGS. 5A to 5C are diagrams for describing execution of the foreign substance removal operation to remove a foreign substance adhering to the imaging plane of the image pickup element 103 in a state where the lens unit 102 is removed from the imaging apparatus 100. FIGS. 5A to 5C each illustrate the image pickup element 103 in the imaging unit 101 of the imaging apparatus 100, and the foreign substance 300 adheres to the imaging plane of the image pickup element 103. The imaging unit 101 rotates about the rotary shaft 301 in the tilting direction.

As illustrated in FIG. 5A, the orientation calculation unit 204 calculates the angle a based on the driving angle of the motor and the configuration of the reduction gear, using the rotation position of the imaging unit 101, which has been detected by the photo-interrupter, as a reference. Thereafter, the rotation angle calculation unit 205 calculates the rotational driving amount for rotating the imaging unit 101 in the tilting direction so that the angle a is 90 degrees.

The rotary drive unit 106 rotates the imaging unit 101 based on the calculation result from the rotation angle calculation unit 205, and positions the imaging plane of the image pickup element 103 to be orthogonal to the gravitational direction as illustrated in FIG. 5B. Thereafter, as illustrated in FIG. 5C, the image pickup element vibration unit 105 is driven to vibrate the image pickup element 103 and remove the foreign substance 300 on the imaging plane of the image pickup element 103. At this time, the foreign substance 300 that has been removed from the imaging plane of the image pickup element 103 drops to the outside of the imaging apparatus 100 (for example, the ground surface). Hence, the foreign substance removed from the image pickup element 103 is prevented from adhering to another part in the imaging unit 101.

Furthermore, when the lens unit 102 is mounted onto the imaging apparatus 100, there is a possibility that a foreign substance adhering to the inside of the lens unit 102 drops to the inside of the imaging unit 101, and adheres to the imaging plane of the image pickup element 103. For such an occasion, the imaging apparatus 100 may execute the foreign substance removal operation after the lens unit 102 is mounted on the imaging apparatus 100. It is possible to remove the foreign substance adhering to the imaging plane of the image pickup element 103 when the lens unit 102 is mounted on the imaging apparatus 100.

In a third exemplary embodiment, a description will be given of a case where the foreign substance removal operation to remove a foreign substance adhering to the imaging plane of the image pickup element 103 is executed at the time of an initialization operation to be performed when the imaging apparatus 100 is powered ON or the like.

Examples of the initialization operation include an operation of setting the rotation position of the imaging unit 101 to be rotated by the rotary drive unit 106 as a reference position. For example, in a case where a plus end, which is one of maximum positions in a rotational driving range of the imaging unit 101 to be rotated by the rotary drive unit 106, is set as the reference position and the photo-interrupter is installed at the plus end, the rotary drive unit 106 rotates the imaging unit 101 to the plus end. The rotary drive unit 106 stops the rotational driving of the imaging unit 101 at a position detected by the photo-interrupter.

In a case where the rotation position of the imaging unit 101 to be rotated by the rotary drive unit 106 is set as the reference position by the initialization operation, it is possible for the rotary drive unit 106 to rotate the imaging unit 101 to a predetermined angle using the position serving as a reference. Hence, in the present exemplary embodiment, after the rotation position of the imaging unit 101 to be rotated by the rotary drive unit 106 is set as the reference position, it is possible for the rotary drive unit 106 to rotate the imaging unit 101 to the predetermined angle without calculating the angle a illustrated in FIG. 3A.

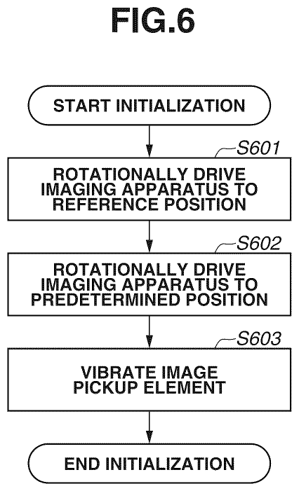

FIG. 6 is a flowchart in a case where the foreign substance removal operation is executed at the time of the initialization operation. Assume that the photo-interrupter is installed at the plus end, which is one of maximum positions in the driving range of the imaging unit 101 to be rotated by the rotary drive unit 106.

In step S601, when the imaging apparatus 100 starts the initialization operation, the rotary drive unit 106 rotates the imaging unit 101 to a position that is detected by the photo-interrupter installed at the plus end serving as the reference position. The rotary drive unit 106 stops the rotational driving of the imaging unit 101 at the position detected by the photo-interrupter.

In step S602, the rotary drive unit 106 rotates the imaging unit 101 so that the imaging plane of the image pickup element 103 is parallel to the gravitational direction, based on the driving angle of the motor and the configuration of the reduction gear, using the position detected by the photo-interrupter in step S601 as a reference.

In step S603, the image pickup element vibration unit 105 is driven to vibrate the image pickup element 103 and remove the foreign substance adhering to the imaging plane of the image pickup element 103, and the present flow ends.

According to the present exemplary embodiment, it is possible to adjust the direction of the imaging plane of the image pickup element 103 at the time of the initialization operation of the imaging apparatus 100 without the need for the user to manually operating the tilting mechanism and easily execute the foreign substance removal operation.

In the present exemplary embodiment, the description has been given of the example in which the foreign substance removal operation is performed when the imaging apparatus 100 is powered on, but the foreign substance removal operation may be performed when the imaging apparatus 100 is powered off or in a case where a sleep mode is set. The foreign substance removal operation is executed when the imaging apparatus 100 is powered on or off or in the case where the sleep mode is set, so that the foreign substance removal operation can be executed on a regular basis.

As described in the second exemplary embodiment, in a case where the imaging apparatus 100 is the interchangeable-lens imaging apparatus, the present flow may be performed together with the initialization operation when the removal of the lens unit 102 is detected.

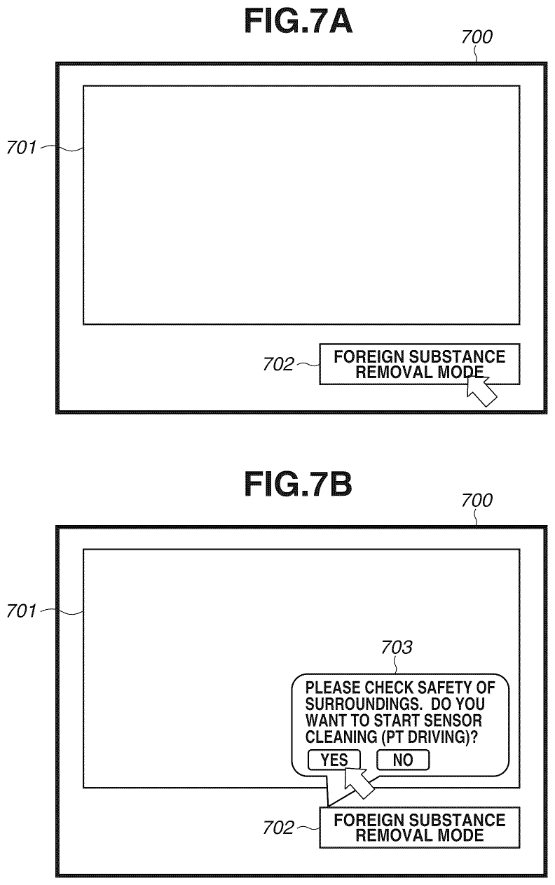

In a fourth exemplary embodiment, a description will be given of a case where the foreign substance removal operation is executed in response to an instruction from a user during an operation of the imaging apparatus 100. FIGS. 7A and 7B are image diagrams each illustrating a display screen to be displayed on a display apparatus 700 as an external apparatus that is connected to the imaging apparatus 100 via the communication unit 203.

An image 701 captured by the imaging apparatus 100 and an operation button 702 for inputting an instruction for operating the imaging apparatus 100 are displayed on the display screen of the display apparatus 700. As illustrated in FIG. 7A, when the user selects the operation button 702 using a controller or the like, a pop-up screen 703 is displayed as illustrated in FIG. 7B. When the user permits the start of the foreign substance removal operation on the pop-up screen 703, the imaging apparatus 100 starts the foreign substance removal operation.

The rotation position of the imaging unit 101 rotated by the rotary drive unit 106 when the user instructs the start of the foreign substance removal operation is stored in the storage unit 209. After removal of the foreign substance adhering to the imaging plane of the image pickup element 103, the rotary drive unit 106 rotates the imaging unit 101 to the rotation position when the user instructs the start of the foreign substance removal operation.

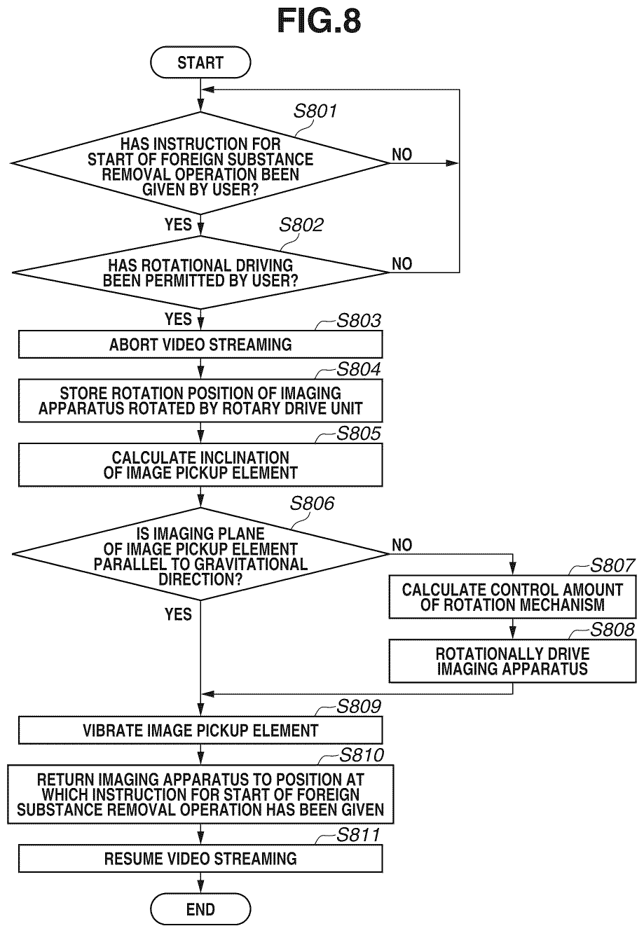

FIG. 8 is a flowchart in a case where the foreign substance removal operation is executed based on the instruction from the user according to the present exemplary embodiment.

In step S801, the control unit 200 determines whether an instruction for start of the foreign substance removal operation has been given by the user. In a case where the control unit 200 determines that the instruction for start of the foreign substance removal operation has been given by the user (YES in step S801), the processing proceeds to step S802. In a case where the control unit 200 determines that the instruction for start of the foreign substance removal operation has not been given by the user (NO in step S801), the processing in step S801 is executed again.

In step S802, the control unit 200 determines whether the user has permitted rotational driving of the imaging unit 101 by the rotary drive unit 106. In a case where the control unit 200 determines that the user has permitted the rotational driving of the imaging unit 101 by the rotary drive unit 106 (YES in step S802), the processing proceeds to step S803. In contrast, in a case where the control unit 200 determines that the user has not permitted the rotational driving of the imaging unit 101 by the rotary drive unit 106 (NO in step S802), the processing proceeds to step S801.

In step S803, the control unit 200 aborts video streaming because a captured video is disturbed during execution of the foreign substance removal operation, and the processing proceeds to step S804.

In step S804, the rotation position of the imaging unit 101 rotated by the rotary drive unit 106 is stored in the storage unit 209, and the processing proceeds to step S805.

In step S805, the orientation calculation unit 204 calculates the angle of the imaging plane of the image pickup element 103 with respect to the gravitational direction based on the driving angle of the motor and the configuration of the reduction gear, using the rotation position detected by the photo-interpreter as a reference, and the processing proceeds to step S806.

In step S806, the control unit 200 determines whether the imaging plane of the image pickup element 103 is parallel to the gravitational direction, based on the angle of the imaging plane of the image pickup element 103 with respect to the gravitational direction, which has been calculated in step S805. In a case where the control unit 200 determines that the imaging plane of the image pickup element 103 is parallel to the gravitational direction (YES in step S806), the processing proceeds to step S809. In a case where the control unit 200 determines that the imaging plane of the image pickup element 103 is not parallel to the gravitational direction (NO in step S806), the processing proceeds to step S807.

In step S807, the rotation angle calculation unit 205 calculates, based on the angle information regarding the angle calculated in step S805, a driving amount of the imaging unit 101 to be driven by the rotary drive unit 106 so that the imaging plane of the image pickup element 103 is parallel to the gravitational direction, and the processing proceeds to step S808.

In step S808, the rotary drive unit 106 rotates the imaging unit 101 based on the driving amount calculated by the rotation angle calculation unit 205, and the processing proceeds to step S809.

In step S809, the image pickup element vibration unit 105 is driven to vibrate the image pickup element 103 and remove the foreign substance adhering to the imaging plane of the image pickup element 103, and the processing proceeds to step S810.

In step S810, the control unit 200 reads out, from the storage unit 209, the stored rotation position of the imaging unit 101 at the time of start of the foreign substance removal operation, the rotary drive unit 106 rotates the imaging unit 101 to the readout position, and the processing proceeds to step S811.

In step S811, the control unit 200 resumes video streaming that has been aborted, and the present flow ends.

According to the present exemplary embodiment, because the direction of the imaging plane of the image pickup element 103 is adjusted without the need for the user to operate the tilting mechanism, it is possible to easily execute the foreign substance removal operation. Since the imaging unit 101 returns to the rotation position when the foreign substance removal operation is instructed after execution of the foreign substance removal operation, it is possible to resume imaging at an imaging angle of view before the foreign substance removal operation is executed.

In the present exemplary embodiment, the description has been given of the example of notifying the user that the rotational driving of the imaging unit 101 is executed at the time of the foreign substance removal operation with reference to FIG. 7B, but a notification about abort of video streaming during the foreign substance removal operation may be made. Making the notification before execution of the foreign substance removal operation makes it possible to inform the user that rotational driving of the imaging apparatus is to be performed and video streaming is to be aborted during execution of the foreign substance removal operation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-099180, filed Jun. 19, 2024, which is hereby incorporated by reference herein in its entirety.

What is claimed is:

1. An imaging apparatus comprising:
an imaging unit including an image pickup element;
a rotary drive unit configured to rotate the imaging unit in a horizontal direction or a vertical direction;
an image pickup element vibration unit configured to vibrate the image pickup element to remove a foreign substance adhering to an imaging plane of the image pickup element; and
a control unit configured to control the image pickup element vibration unit to operate in a state where the imaging unit is rotated by the rotary drive unit so that the imaging plane of the image pickup element is at a predetermined angle with respect to a gravitational direction.

2. The imaging apparatus according to claim 1, further comprising a rotation angle calculation unit configured to calculate the predetermined angle.

3. The imaging apparatus according to claim 2, further comprising a rotation position detection unit configured to detect a rotation position of the imaging unit,
wherein the rotation angle calculation unit is configured to calculate the predetermined angle based on the rotation position detected by the rotation position detection unit.

4. The imaging apparatus according to claim 2, further comprising an orientation detection unit configured to detect an orientation of the imaging unit,
wherein the rotation angle calculation unit is configured to calculate the predetermined angle based on a detection result from the orientation detection unit.

5. The imaging apparatus according to claim 1, further comprising an absorption member configured to absorb a foreign substance that has been removed from the imaging plane of the image pickup element by the image pickup element vibration unit.

6. The imaging apparatus according to claim 1, wherein the imaging unit includes a lens mount unit to which a lens unit is detachably mounted.

7. The imaging apparatus according to claim 6, wherein, in a case where the control unit controls the image pickup element vibration unit to execute a foreign substance removal operation in a state where the lens unit is removed, the control unit is configured to control the rotary drive unit to rotationally drive the imaging unit until the imaging plane of the image pickup element becomes orthogonal to the gravitational direction and thereafter control the image pickup element vibration unit to execute the foreign substance removal operation.

8. The imaging apparatus according to claim 1, wherein the control unit is configured to control the image pickup element vibration unit to operate and thereafter control the rotary drive unit to rotate the image pickup element to the predetermined angle.

9. The imaging apparatus according to claim 1, wherein the control unit is configured to control the image pickup element vibration unit to execute a foreign substance removal operation at time of an initialization operation of the imaging apparatus.

10. The imaging apparatus according to claim 1, wherein the control unit is configured to control the image pickup element vibration unit to execute a foreign substance removal operation based on an instruction from a user.

11. The imaging apparatus according to claim 1, wherein the control unit is configured to perform control not to stream a video captured by the imaging unit during execution of a foreign substance removal operation by the image pickup element vibration unit.

12. The imaging apparatus according to claim 1, wherein the control unit is configured to control the rotary drive unit not to execute rotational driving of the imaging unit except rotational driving for a foreign substance removal operation during execution of the foreign substance removal operation by the image pickup element vibration unit.

13. A method of controlling an imaging apparatus, the imaging apparatus including an imaging unit including an image pickup element, a rotary drive unit configured to rotate the imaging unit in a horizontal direction or a vertical direction, and an image pickup element vibration unit configured to vibrate the image pickup element to remove a foreign substance adhering to an imaging plane of the image pickup element, the method comprising:
controlling the image pickup element vibration unit to operate in a state where the imaging unit is rotated by the rotary drive unit so that the imaging plane of the image pickup element is at a predetermined angle with respect to a gravitational direction.
